(19) United States
(12) Patent Application Publication
(10) Pub. No.: US 2003/0081663 A1
(43) Pub. Date: May 1, 2003

(54) Interface circuit of differential signaling system

(76) Inventor: Hideo Nagano, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/160,096

(22) Filed: Jun. 4, 2002

(30) Foreign Application Priority Data
Nov. 1, 2001 (JP) 2001-336817

(51) Int. Cl. H04B 1/38

(52) U.S. Cl. 375/220; 375/257

(57) ABSTRACT

A first differential signal received at an input terminal is input to non-inversion terminals of a first comparator and a receiving end device. A second differential signal lower than the first differential signal is received at another input terminal and is input to inversion terminals of a second comparator and the receiving end device. A first reference voltage higher than the first differential signal is applied to an inversion terminal of the first comparator, and a second reference voltage lower than the second differential signal is applied to a non-inversion terminal of the second comparator. When one input terminal is open-circuited or short-circuited, a voltage higher than the first reference voltage or a voltage lower than the second reference voltage is applied to the non-inversion terminal of the first comparator or the inversion terminal of the second comparator.

### BACKGROUND OF THE INVENTION

1. Field of the Invention

The present invention relates to an interface circuit used for data transmission, and more particularly to an interface circuit used for a differential signaling system.

2. Description of Related Art

A differential signaling system, for example, used for low voltage differential signaling (LVDS) is known. In this differential signaling system, low noise signaling is performed at high speed and low voltage by transmitting data between a transmitting end (Tx) and a receiving end (Rx) through a cable.

FIG. 6 is a view schematically showing a differential signaling system. In FIG. 6, 11 indicates a transmitting end device (or a transmitting end operational amplifier), 12 indicates a cable, 13 indicates a receiving end device (or a receiving end operational amplifier), and 14 indicates a termination resistor (a resistance value is equal to 100Ω in case of LVDS). In this differential signaling system, there is a case where the cable 12 is plugged in or pulled out while supplying electric power to both the transmitting end device 11 and the receiving end device 13. Therefore, it is required to cope with this case in the differential signaling system. For example, after the cable 12 is pulled out from the operational amplifier 11 or 13, in cases where the cable 12 is plugged in so as to erroneously open-circuit either a plus terminal (or a non-inversion input terminal: +) or a minus terminal (or an inversion input terminal: −) of the operational amplifier or so as to erroneously short-circuit the input terminals of the operational amplifier with each other, it is required that no adverse influence exerts on the differential signaling system, and it is required to remove factors which lower the reliability of the differential signaling system. For example, even though these erroneous operation is performed, it is required to prevent that current excessively flows through the receiving end device 13 or abnormal oscillation occurs in the receiving end device 13 and to prevent the receiving end device 13 from being broken.

To remove the factors lowering the reliability of the differential signaling system, an interface circuit of a communication control device disclosed in Published Unexamined Japanese Patent Application No. H6-152658 (1994) is, for example, known as a prior art.

In this prior art, reception data input to a pair of input terminals through a cable is input to both a non-inversion input terminal and an inversion input terminal of a receiver through a termination resistor in a differential signaling system, a pull-up resistor is connected to the non-inversion input terminal of the receiver, and a pull-down resistor is connected to the inversion input terminal of the receiver, and both the non-inversion input terminal and the inversion input terminal of the receiver are fixed to prescribed electric potentials respectively due to the pull-up resistor and the pull-down resistor. Therefore, even though the non-inversion input terminal or the inversion input terminal is open-circuited, an input signal output from the receiver is stabilized.

In detail, in cases where it is assumed that the prior art is applied for the differential signaling system shown in FIG. 6, a high voltage is applied from an electric power source to the non-inversion input terminal of the receiving end device 13 through the pull-up resistor, and the inversion input terminal of the receiving end device 13 is grounded through the pull-down resistor. Therefore, when the input terminals are open-circuited, the non-inversion input terminal is fixed to a high (H) level, and the inversion input terminal is fixed to a low (L) level, no excessive current flows through the receiving end device 13, and no abnormal oscillation occurs in the operational amplifier 13. Also, when the input terminals are set to a short-circuiting state with each other to be short-circuited each other, the non-inversion input terminal and the inversion input terminal are fixed to divided voltages which are determined by resistance values of the pull-up resistor, the pull-down resistor and the termination resistor. Therefore, no excessive current flows through the receiving end device 13, and no abnormal oscillation occurs in the operational amplifier 13.

Because the conventional interface circuit composed of both the receiving end device 13 and the termination resistor 14 has the above-described configuration, the receiving end device 13 can be prevented from being broken. However, because signal waveform and signal voltage are standardized in the differential signaling system such as LVDS, adverse influence is exerted on the receiving end device 13 in the data transmission when the pull-up resistor and the pull-down resistor are connected to the receiving end device 13. That is to say, in cases where the pull-up resistor and the pull-down resistor are added to the receiving end device 13, a problem has arisen that signal transmission characteristics such as signal waveform and signal voltage become out of standardized values.

Also, when the input terminal of the receiving end device 13 is open-circuited or short-circuited, a time constant is changed due to resistance values of the pull-up resistor and the pull-down resistor so as to lengthen a time period required to reach a stabilized voltage. Therefore, a problem has arisen that the receiving end device 13 is adversely influenced by the open-circuited input terminal or the short-circuited input terminals.

### SUMMARY OF THE INVENTION

An object of the present invention is to provide, with due consideration to the drawbacks of the conventional interface circuit, an interface circuit in which an excessive current flowing through a receiving end device and the occurrence of abnormal oscillation in the receiving end device due to either an open-circuiting state of an input terminal or a short-circuiting state of input terminals are prevented while maintaining excellent signal transmission characteristics without exerting adverse influence on the receiving end device.

The object is achieved by the provision of an interface circuit including a receiving end operational amplifier, having a non-inversion input terminal, an inversion input terminal and an output terminal, for receiving a differential signal at the non-inversion input terminal through a data transmission line, a termination resistor and a first signal input terminal as a first signal, receiving another differential signal at the inversion input terminal through the data transmission line, the termination resistor and a second signal input terminal as a second signal, and sending out an output signal from the output terminal, and impedance control means for setting the receiving end operational amplifier to a high impedance state in a case where the first signal input terminal or the second signal input terminal is set to an open-circuiting state or a short-circuiting state.

In the above configuration, the receiving end operational amplifier is set to a high impedance state in cases where the first signal input terminal or the second signal input terminal is set to an open-circuiting state or a short-circuiting state. Therefore, an excessive current flowing through the receiving end operational amplifier (or a receiving end device) and the occurrence of abnormal oscillation in the receiving end operational amplifier due to either an open-circuiting state of the first or second signal input terminal or a short-circuiting state of the first and second signal input terminals can be prevented while maintaining excellent signal transmission characteristics without exerting adverse influence on the receiving end operational amplifier.

### BRIEF DESCRIPTION OF THE DRAWINGS

FIG. 1 is a circuit view of an interface circuit according to a first embodiment of the present invention;

FIG. 2 is a view showing the relationship among a first reference voltage, a second reference voltage and levels of differential signals in the interface circuit shown in FIG. 1;

FIG. 3 is a circuit view of a reference voltage producing circuit, which is used for the interface circuit of the first embodiment, according to a second embodiment of the present invention;

FIG. 4 is a circuit view of an interface circuit according to a third embodiment of the present invention;

FIG. 5 is a circuit view of a reference voltage producing circuit used for the interface circuit shown in FIG. 4; and

FIG. 6 is a view schematically showing a differential signaling system.

### DETAILED DESCRIPTION OF THE PREFERRED EMBODIMENTS

Embodiments of the present invention will now be described with reference to the accompanying drawings.

Embodiment 1

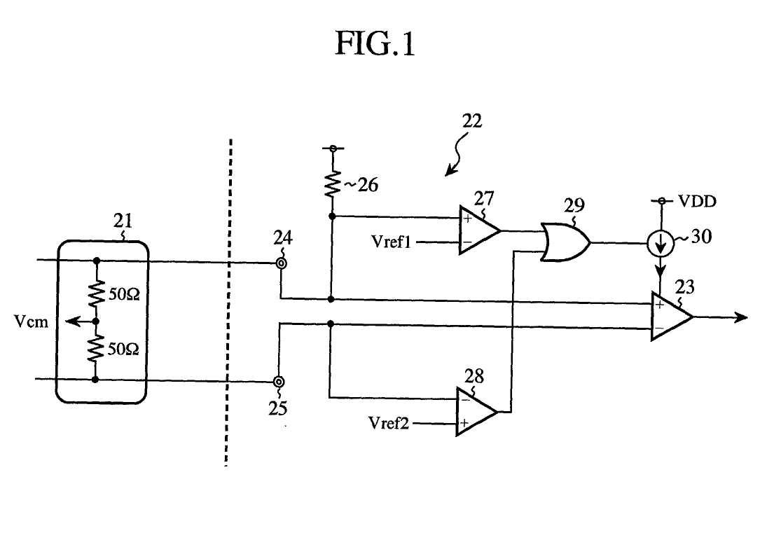

FIG. 1 is a circuit view of an interface circuit according to a first embodiment of the present invention. In FIG. 1, 21 indicates a termination resistor, and 22 indicates a receiving end chip. In the receiving end chip 22, a receiving end device (or a receiving end operational amplifier) 23, a receiving end (Rx) non-inversion(+) input terminal (or a first signal input terminal) 24, and a Rx inversion (−) input terminal (or a second signal input terminal) 25 are disposed. The Rx non-inversion input terminal 24 and the Rx inversion input terminal 25 are respectively connected to receiving ends of a cable (not shown) through the termination resistor 21, and a transmitting end device (not shown) is connected to transmitting ends of the cable. Also, the Rx non-inversion input terminal 24 is connected to a non-inversion (+) input terminal of the receiving side operational amplifier 23, and the Rx inversion input terminal 25 is connected to an inversion (−) input terminal of the receiving side operational amplifier 23.

Also, a pull-up resistor (or a resistive element) 26, a first comparator 27, a second comparator 28 and an OR gate 29 are disposed in the receiving end chip 22. A non-inversion (+) input terminal of the first comparator 27 is connected to the Rx non-inversion input terminal 24, a source voltage is applied from an electric power source having a power supply voltage VDD to the non-inversion input terminal of the first comparator 27 through the pull-up resistor 26, and a first reference voltage Vref1 is applied to an inversion (−) input terminal of the first comparator 27. Also, an inversion (−) input terminal of the second comparator 28 is connected to the Rx inversion input terminal 25, and a second reference voltage Vref2 is applied to a non-inversion (+) input terminal of the second comparator 28.

An output signal of the first comparator 27 and an output signal of the second comparator 28 are fed to the OR gate 29, a current source 30 is adjusted according to an output signal of the OR gate 29, and an operation current is fed from the current source 30 to the receiving end device 23. In the example shown in FIG. 1, an interface circuit of the first embodiment comprises the receiving end device 23, the pull-up resistor 26, the first comparator 27, the second comparator 28, the OR gate 29 and the current source 30.

Next, an operation of the interface circuit will be described below.

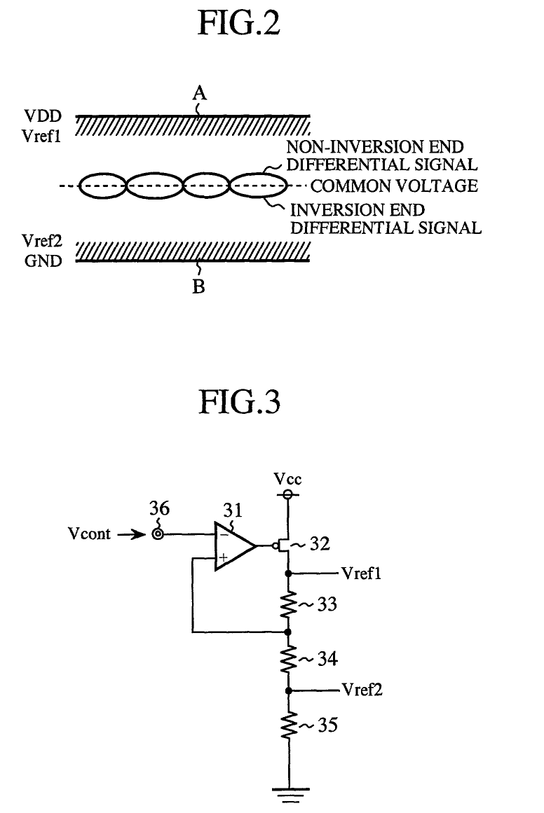

FIG. 2 is a view showing the relationship among the first reference voltage Vref1, the second reference voltage Vref2 and levels of differential signals in the interface circuit shown in FIG. 1. It is assumed that the interface circuit shown in FIG. 1 is used for the LVDS system, and an operation of the interface circuit is described with reference to FIG. 1 and FIG. 2.

In the LVDS system, a resistance value of the termination resistor 21 is set to 100 Ω, and a common voltage Vcm is set to 1.25 V. When data transmission is performed, a non-inversion (+) differential signal (or a first signal) having a voltage higher than the common voltage Vcm is input to the Rx non-inversion input terminal 24, and an inversion (−) differential signal (or a second signal) having a voltage lower than the common voltage Vcm is input to the Rx inversion input terminal 25. As shown in FIG. 2, the first reference voltage Vref1 is set to be higher than the non-inversion end differential signal and to be lower than the power supply voltage VDD, and the second reference voltage Vref2 is set to be lower than the inversion end differential signal and to be higher than a ground level GND.

In cases where neither the Rx non-inversion input terminal 24 nor the Rx inversion input terminal 25 is set to an open-circuiting state (or a short-circuiting state) during the data transmission, the voltage (that is, the voltage of the non-inversion end differential signal) applied to the non-inversion input terminal of the first comparator 27 is lower than the first reference voltage Vref1 applied to the inversion input terminal of the first comparator 27. Therefore, the output signal of the first comparator 27 is set to the L level because. Also, because the second reference voltage Vref2 applied to the non-inversion input terminal of the second comparator 28 is lower than the voltage of the inversion end differential signal fed to the inversion input terminal of the second comparator 28, the output signal of the second comparator 28 is set to the L level. Therefore, an output signal of the OR gate 29 is set to the L level. In the example of FIG. 1, when the signal set to the low level is fed from the OR gate 29 to the current source 30, the current source 30 is set to an on state so as to supply a current from the current source 30 to the receiving end device 23, and the receiving end device 23 is set to an operation state. Therefore, an output signal (or an operational amplifier output signal) depending on both the non-inversion end differential signal and the inversion end differential signal is output from the receiving end device 23 to a circuit (not shown) placed in a latter stage. In contrast, in cases where the Rx non-inversion input terminal 24 is set to an open-circuiting state to be open-circuited, a prescribed divided voltage determined by the resistance value R1 of the pull-up resistor 26 is applied to the non-inversion input terminal of the first comparator 27. This prescribed divided voltage is placed in a region indicated by a shadowed portion A of FIG. 2. Therefore, the prescribed divided voltage placed between the power supply voltage VDD and the first reference voltage Vref1 is applied to the non-inversion input terminal of the first comparator 27, the prescribed divided voltage applied to the non-inversion input terminal becomes higher than the first reference voltage Vref1 applied to the inversion input terminal in the first comparator 27, the signal (or a first detection signal) set to the H level is output from the first comparator 27 to the OR gate 29, the signal set to the H level is output from the OR gate 29 to the current source 30, the current source 30 is set to an off state so as to stop the feeding of a current to the receiving end device 23, and the receiving end device 23 is set to a high impedance state.

Therefore, in cases where the Rx non-inversion input terminal 24 is set to an open-circuiting state, because the receiving end device 23 is set to a high impedance state, there is no probability that excessive current flows through the receiving end chip 22 or abnormal oscillation occurs in the receiving end device 23.

Also, in cases where the Rx inversion input terminal 25 is set to an open-circuiting state, a prescribed voltage near to the ground level GND is applied to the inversion input terminal of the second comparator 28. This prescribed voltage is placed in a region indicated by a shadowed portion B of FIG. 2. Therefore, the prescribed voltage placed between the ground level GND and the second reference voltage Vref2 is applied to the inversion input terminal of the second comparator 28, the second reference voltage Vref2 applied to the non-inversion input terminal becomes higher than the prescribed voltage applied to the inversion input terminal in the second comparator 28, a signal (or a second detection signal) set to the H level is output from the second comparator 28 to the OR gate 29, the signal set to the H level is output from the OR gate 29 to the current source 30, the current source 30 is set to an off state so as to stop the feeding of a current to the receiving end device 23, and the receiving end device 23 is set to a high impedance state.

Therefore, in cases where the Rx inversion input terminal 25 is set to an open-circuiting state, because the receiving end device 23 is set to a high impedance state, there is no probability that excessive current flows through the receiving end chip 22 or abnormal oscillation occurs in the receiving end device 23.

Also, in cases where the Rx non-inversion input terminal 24 and the Rx inversion input terminal 25 are set to a short-circuiting state respectively to be short-circuited each other, the prescribed divided voltage determined by the resistance value R1 of the pull-up resistor 26 is applied to the non-inversion input terminal of the first comparator 27 in the same manner as in the case of the Rx non-inversion input terminal 24 set to an open-circuiting state, and the receiving end device 23 is set to a high impedance state. Therefore, there is no probability that excessive current flows through the receiving end chip 22 or abnormal oscillation occurs in the receiving end device 23.

As is easily realized in the above description, the combination of the pull-up resistor 26, the first and second comparators 27 and 28, the OR gate 29 and the current source 30 functions as an impedance control means, the combination of the pull-up resistor 26, the first and second comparators 27 and 28 functions as a detecting means, and the combination of the OR gate 29 and the current source 30 functions as an operation current control means. As is described above, in the first embodiment, in cases where the Rx non-inversion input terminal 24 or the Rx inversion input terminal 25 is set to an open-circuiting state or the Rx non-inversion input terminal 24 and the Rx inversion input terminal 25 are short-circuited each other, the receiving end device 23 is set to a high impedance state. Therefore, there is no probability that excessive current flows through the receiving end chip 22 or abnormal oscillation occurs in the receiving end device 23.

Also, in the first embodiment, it is detected whether or not the voltage at the Rx non-inversion input terminal 24 is higher than the first reference voltage Vref1, it is detected whether or not the voltage at the Rx inversion input terminal 25 is lower than the second reference voltage Vref2, it is detected whether or not the Rx non-inversion input terminal 24 or the Rx inversion input terminal 25 is set to an open-circuiting state or a short-circuiting state, and the current source 30 is controlled to the on state or the off state by using the first and second comparators 27 and 28. Therefore, in cases where it is detected that the Rx non-inversion input terminal 24 or the Rx inversion input terminal 25 is set to an open-circuiting state or a short-circuiting state, the receiving end device 23 is set to a high impedance state. Accordingly, signal transmission characteristics such as signal waveform or signal voltage can be preferably maintained without being placed out of standards of the LVDS.

Embodiment 2

FIG. 3 is a circuit view of a reference voltage producing circuit (or reference voltage adjusting means), which is included in the interface circuit of the first embodiment, according to a second embodiment of the present invention. In a reference voltage producing circuit, the first and second reference voltages Vref1 and Vref2 are produced. In FIG. 3, 31 indicates a comparator, 32 indicates a transistor, and 33 to 35 indicate a plurality of resistors respectively. The resistor 33 has a resistance value R2, the resistor 34 has a resistance value R3, and the resistor 35 has a resistance value R4. A non-inversion input terminal of the comparator 31 is connected to a control voltage input terminal 36, and an output terminal of the comparator 31 is connected to a gate electrode of the transistor 32. A source voltage Vcc is applied to a source electrode of the transistor 32, and a drain electrode of the transistor 32 is connected to the transistor 33. The transistors 33, 34 and 35 are serially connected to each other in that order, and the resistor 35 is grounded.

A connection point of the transistor 32 and the resistor 33 is set as an output terminal of the first reference voltage Vref1, a connection point of the resistor 33 and the resistor 34 is connected to a non-inversion input terminal of the comparator 31, and a connection point of the resistor 34 and the resistor 35 is set as an output terminal of the second reference voltage Vref2.

The interface circuit shown in FIG. 1 further comprises the reference voltage producing circuit shown in FIG. 3.

Next, an operation of the reference voltage producing circuit will be described below.

In the same manner as the operation described with reference to FIG. 1 and FIG. 2, in cases where the Rx non-inversion input terminal 24 or the Rx inversion input terminal 25 is set to an open-circuiting state or the Rx non-inversion input terminal 24 and the Rx inversion input terminal 25 are short-circuited each other, the receiving end device 23 is set to a high impedance state. To detect the open-circuiting state or the short-circuiting state of the Rx non-inversion input terminal 24 and/or the Rx inversion input terminal 25, the first and second reference voltages Vref1 and Vref2 are fed to the first and second comparators 27 and 28 respectively (refer to FIG. 1 and FIG. 2).

These first and second reference voltages Vref1 and Vref2 are produced in the reference voltage producing circuit shown in FIG. 3. In detail, a control voltage Vcont is applied to the control voltage input terminal 36 and is applied to the inversion terminal of the comparator 31. In cases where a terminal voltage V+applied to the non-inversion terminal of the comparator 31 is higher than the control voltage Vcont (V+>Vcont), a signal of the high level is output from the comparator 31, and the transistor 32 is set to an off state. That is to say, the transistor 32 is turned off. When a resistance value of the transistor 32 turned off is expressed by T_{ROFF}, the first and second reference voltages Vref1 and Vref2 are respectively set to values which are respectively determined by dividing the source voltage Vcc according to the resistors 33 to 35 having the resistance values R2 to R4 and the transistor 32 having the resistance value T_{ROFF}. That is to say, the first reference voltage Vref1 is set to (R2+R3+R4)×Vcc/(T_{ROFF}+R2+R3+R4), and the second reference voltage Vref2 is set to R4×Vcc/(T_{ROFF}+R2+R3+R4). In this case, the terminal voltage V+is set to (R3+R4)×Vcc/(T_{ROFF}+R2+R3+R4).

In contrast, in cases where the terminal voltage V+is equal to or lower than the control voltage Vcont (V+≦Vcont), a signal of the low level is output from the comparator 31, and the transistor 32 is set to an on state. That is to say, the transistor 32 is turned on. When a resistance value of the transistor 32 turned on is expressed by T_{RON}, the first and second reference voltages Vref1 and Vref2 are respectively set to values which are respectively determined by dividing the source voltage having the value Vcc according to the resistors 33 to 35 having the resistance values R2 to R4 and the transistor 32 having the resistance value T_{RON}. That is to say, the first reference voltage Vref1 is set to (R2+R3+R4)×VCC/(T_{RON}+R2+R3+R4), and the second reference voltage Vref2 is set to R4×Vcc/(T_{RON}+R2+R3+R4). In this case, the terminal voltage V+is set to (R3+R4)×Vcc/(T_{RON}+R2+R3+R4). Because the resistance value T_{RON} of the transistor 32 turned on is considerably small as compared with the resistance values R2 to R4, the first reference voltage Vref1=(R2+R3+R4)×Vcc/(R2+R3+R4), the second reference voltage Vref2=R4×Vcc/(R2+R3+R4), and V+=(R3+R4)×Vcc/(R2+R3+R4) are substantially set.

Therefore, because the first and second reference voltages Vref1 and Vref2 are adjusted according to the control voltage Vcont applied from the outside, the first and second reference voltages Vref1 and Vref2 can be arbitrarily changed. Here, the control voltage Vcont is, for example, changed by using a variable voltage transformer.

As is described above, in the second embodiment, no excessive current flows through the receiving end chip 22, and no abnormal oscillation occurs in the receiving side operational amplifier 23. Therefore, excellent signal transmission characteristics can be maintained.

Also, even though the level of the non-inversion differential signal and the level of the inversion differential signal are changed, because the first and second reference voltages Vref1 and Vref2 can be arbitrarily changed, the excellent signal transmission characteristics can be reliably maintained.

Embodiment 3

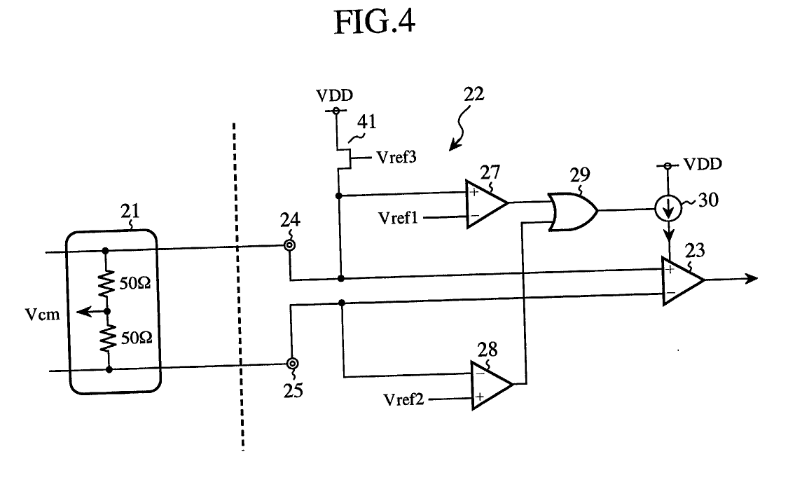

FIG. 4 is a circuit view of an interface circuit according to a third embodiment of the present invention. The constituent elements, which are the same as those shown in FIG. 1, are indicated by the same reference numerals as those of the constituent elements shown in FIG. 1, and additional description of those constituent elements is omitted. In FIG. 4, 41 indicates a transistor. The transistor 41 is used in place of the pull-up resistor 26 used in the first embodiment, and a third reference voltage Vref3 is applied on a gate of the transistor 41 so as to turn on the transistor 41 in a linear region. The transistor 41 turned on in its linear region functions as a resistive element.

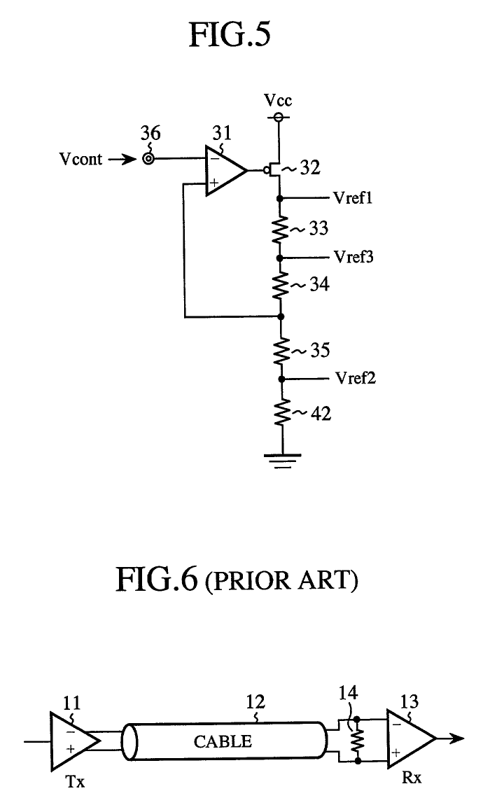

FIG. 5 is a circuit view of a reference voltage producing circuit (or reference voltage adjusting means) in which the first, second and third reference voltages Vref1, Vref2 and Vref3 used for the interface circuit shown in FIG. 4 are produced. The constituent elements, which are the same as those shown in FIG. 3, are indicated by the same reference numerals as those of the constituent elements shown in FIG. 3, and additional description of those constituent elements is omitted. As shown in FIG. 5, a resistor 42 having a resistance value R5 is disposed in the reference voltage producing circuit. The resistors 33, 34, 35 and 42 are serially connected to each other in that order, and the resistor 42 is earthed. A connection point of the transistor 32 and the resistor 33 is set as an output terminal of the first reference voltage Vref1, and a connection point of the resistor 33 and the resistor 34 is set as an output terminal of the third reference voltage Vref3. Also, a connection point of the resistor 34 and the resistor 35 is connected to the non-inversion input terminal of the comparator 31, and a connection point of the resistor 35 and the resistor 42 is set as an output terminal of the second reference voltage Vref2.

The interface circuit shown in FIG. 4 further comprises the reference voltage producing circuit shown in FIG. 5.

Next, an operation of the interface circuit including the reference voltage producing circuit will be described below with reference to FIG. 4 and FIG. 5.

In the same manner as the operation described with reference to FIG. 1 and FIG. 2, in cases where the Rx non-inversion input terminal 24 or the Rx inversion input terminal 25 is set to an open-circuiting state or the Rx non-inversion input terminal 24 and the Rx inversion input terminal 25 are short-circuited each other, the receiving end device 23 is set to a high impedance state. To detect the open-circuiting state or the short-circuiting state of the Rx non-inversion input terminal 24 and/or the Rx inversion input terminal 25, the first and second reference voltages Vref1 and Vref2 are fed from the reference voltage producing circuit shown in FIG. 5 to the first and second comparators 27 and 28 respectively.

As is described with reference to FIG. 3, a control voltage Vcont is applied to the control voltage input terminal 36 and is applied to the inversion terminal of the comparator 31. In cases where a terminal voltage V+applied to the non-inversion terminal of the comparator 31 is higher than the control voltage Vcont (V+>Vcont), a signal of the high level is output from the comparator 31, and the transistor 32 is set to an off state. In this case, the first reference voltage Vref1 is set to (R2+R3+R4+R5)×Vcc/(T_{ROFF}+R2+R3+R4+R5), and the third reference voltage Vref3 is set to (R3+R4+R5)×Vcc/(T_{ROFF}+R2+R3+R4+R5). Also, the terminal voltage V+is set to (R4+R5)×Vcc/(T_{ROFF}+R2+R3+R4+R5), and the second reference voltage Vref2 is set to R5×Vcc/(T_{ROFF}+R2+R3+R4+R5).

In contrast, in cases where the terminal voltage V+is equal to or lower than the control voltage Vcont (V+≦Vcont), a signal of the low level is output from the comparator 31, and the transistor 32 is set to an on state. In this case, the first reference voltage Vref1 is set to (R2+R3+R4+R5)×Vcc/(T_{RON}+R2+R3+R4+R5), and the third reference voltage Vref3 is set to (R3+R4+R5)×Vcc/(T_{RON}+R2+R3+R4+R5). Also, the terminal voltage V+is set to (R4+R5)×Vcc/(T_{RON}+R2+R3+R4+R5), and the second reference voltage Vref2 is set to R5×Vcc/(T_{RON}+R2+R3+R4+R5).

Therefore, the first, second and third reference voltages Vref1, Vref2 and Vref3 are adjusted according to the control voltage Vcont applied from the outside, the first, second and third reference voltages Vref1, Vref2 and Vref3 can be arbitrarily changed. Also, because the third reference voltage Vref3 is applied on the gate of the transistor 41 so as to turn on the transistor 41 in a linear region, the transistor 41 turned on in its linear region can function as a resistive element in place of the pull-up resistor 26.

As is easily realized in the above description, the combination of the transistor 41, the first and second comparators 27 and 28, the OR gate 29 and the current source 30 functions as an impedance control means, and the combination of the transistor 41, the first and second comparators 27 and 28 functions as a detecting means.

As is described above, in the third embodiment, because the transistor 41 turned on in its linear region can function as a resistive element, no excessive current flows through the receiving end chip 22, and no abnormal oscillation occurs in the receiving side operational amplifier 23. Therefore, excellent signal transmission characteristics can be maintained in the interface circuit in the same manner as in the first embodiment.

Also, in the third embodiment, because the transistor 41 turned on in its linear region is used as a resistive element in place of the pull-up resistor 26, a small-sized interface circuit can be manufactured as compared with that in the first embodiment.

What is claimed is:

1. An interface circuit, which is connected to a data transmission line through a termination resistor at both a first signal input terminal and a second signal input terminal and receives a pair of differential signals transmitted through the data transmission line as reception data, comprising:
a receiving end operational amplifier, having a non-inversion input terminal, an inversion input terminal and an output terminal, for receiving one differential signal at the non-inversion input terminal through the first signal input terminal as a first signal, receiving the other differential signal at the inversion input terminal through the second signal input terminal as a second signal, and sending out an output signal from the output terminal; and
impedance control means for setting the receiving end operational amplifier to a high impedance state in a case where the first signal input terminal or the second signal input terminal is set to an open-circuiting state or a short-circuiting state.

2. An interface circuit according to claim 1, wherein the impedance control means comprises:
detecting means for sending out a detection signal indicating that the first signal input terminal or the second signal input terminal is set to the open-circuiting state or the short-circuiting state; and
operation current control means for controlling an operation current fed to the receiving end operational amplifier according to the detection signal sent out from the detecting means to set the receiving end operational amplifier to the high impedance state.

3. An interface circuit according to claim 2, wherein the detecting means comprises:
a first comparator, having both a non-inversion input terminal connected to both a line, to which a source voltage is applied from an electric power source through a resistive element having a prescribed value, and a line connected to the first signal input terminal and an inversion input terminal, for receiving a first reference voltage higher than a voltage of the first signal at the inversion input terminal and sending out a first detection signal as the detection signal indicating that the first signal input terminal is set to the open-circuiting state; and
a second comparator, having both an inversion input terminal connected to the second signal input terminal and a non-inversion input terminal, for receiving a second reference voltage lower than a voltage of the second signal at the non-inversion input terminal and sending out a second detection signal as the detection signal indicating that the second signal input terminal is set to the open-circuiting state, and
the operation current control means is set to an off state and stops the feeding of the operation current to the receiving end operational amplifier in a case where the first detection signal or the second detection signal is received from the first comparator or the second comparator.

4. An interface circuit according to claim 3, wherein the first detection signal is sent out from the first comparator in a case where the first signal input terminal and the second signal input terminal are set to the short-circuiting state with each other.

5. An interface circuit according to claim 3, further comprising:
reference voltage adjusting means for adjusting both the first reference voltage received by the first comparator and the second reference voltage received by the second comparator according to a control voltage applied from an outside.

6. An interface circuit according to claim 3, in which the detecting means further comprises a transistor, which is turned on according to a third reference voltage, as the resistive element.

7. An interface circuit according to claim 6; in which the third reference voltage is lower than the first reference voltage and is higher than the second reference voltage.

8. An interface circuit according to claim 5, in which the detecting means further comprises a transistor, which is turned on according to a third reference voltage, as the resistive element, and the third reference voltage is produced by the reference voltage adjusting means according to the control voltage applied from the outside.
